(19) United States
(12) Patent Application Publication
(10) Pub. No.: US 2017/0132532 A1
(43) Pub. Date: May 11, 2017

(54) LOCATION-BASED MATCHING OF TRUCKERS AND LOADS

(71) Applicant: Charles F. Myers, Midlothian, VA (US)

(72) Inventor: Charles F. Myers, Midlothian, VA (US)

(21) Appl. No.: 14/933,886

(22) Filed: Nov. 5, 2015

(51) Int. Cl. G06Q 10/02; G06Q 10/10; G06Q 10/08; H04W 4/02; H04W 68/00

(52) U.S. Cl. CPC G06Q 10/02; H04W 4/021; H04W 68/005; G06Q 10/0833; G06Q 10/1097; G06Q 50/30

(57) ABSTRACT

Systems and methods are disclosed to allow truckers and shippers to locate each other based on location, shipping criteria and trucker acceptance criteria through an on-line trucker board portal.

### BACKGROUND

The present application relates to location-based matching of truckers and loads.

One of the greatest challenges for an independent owner-operator or small fleet owner (capacity owner or carrier) is finding loads. The difficulty of finding truckers has led to the emergence of freight brokers who are licensed individuals or corporations that help make a shipper and carriers successful in the transporting of freight. Lload matching relies on the carrier finding the load and contacting the broker, leaving the broker with only a manual calling method for finding a carrier with an available load.

Recently, carriers or capacity owners have used computerized load services called load boards to search for and find loads. Loads are generally put on the load board by a shipper or freight broker (freight owners) who is seeking the services of an available truck or capacity owner to move the freight posted on the load board, and the truck or capacity owner will find a load and will call the freight owner and attempt to book the load in question. Many times the load is already booked and the truck or capacity owner will have to go back to the load board, initiate another load search, find another load and call the freight owner to attempt to book the load. This process can be repeated several times before the truck or capacity owner is successful in booking a load.

### SUMMARY

Systems and methods are disclosed to conveniently match truckers and shippers based on locations of truckers and loads using an on-line trucker portal.

Advantages of the system may include one or more of the following. Posting capacity can be done without the time consuming search of truck boards. The information is centralized so that once done, the trucker availability, profile, and capacity information can be viewed by a variety of uses and available much sooner to the freight owner. Once the freight owner sees the available capacity, he/she could immediately engage the capacity owner and negotiate for his/her services. Thus, the capacity owner would not have to wait long for a booking and would be able to again be generating revenue from the engagement of the transportation asset. The system helps truckers find perfect client ahead of time. Truckers can build loyalty with large shipper or freight brokerage who pays well and who needs services regularly. The rating system allows truckers and shippers to operate on the basis of quality and service rather than being completely focused on getting the cheapest rate all the time.

### BRIEF DESCRIPTION OF THE DRAWINGS

FIG. 1A shows an exemplary environment for matching truckers to loads.

FIG. 1B shows an exemplary process for matching truckers to loads.

FIG. 1C shows an exemplary system to match shippers to truckers.

FIG. 1D shows an exemplary process to match shippers to truckers.

FIG. 1E shows a corresponding user interface for a trucker looking for a customer.

FIG. 1F shows an exemplary process to match truckers to shippers.

FIG. 2 is a network diagram depicting an online shipping service transaction processing system for an automated transportation marketplace.

FIG. 3 shows an exemplary system to capture truck profiles for the marketplace load book.

FIG. 4 shows an exemplary user interface of the Trucker Path app for trucker.

FIG. 5 shows an exemplary user interface where shipper can request bids for shipping services.

FIG. 6 illustrates an exemplary user interface for tracking shipping progress.

### DETAILED DESCRIPTION

A method and apparatus supporting an automated transportation marketplace are described. The system provides the ability for a broker to see on a map available carriers for transporting loads and conversely for carriers to see brokers or freight owners who need transportation services.

In the following description, for purposes of explanation, numerous specific details are set forth in order to provide a thorough understanding of the present invention. It will be evident, however, to one skilled in the art that the present invention may be practiced without these specific details.

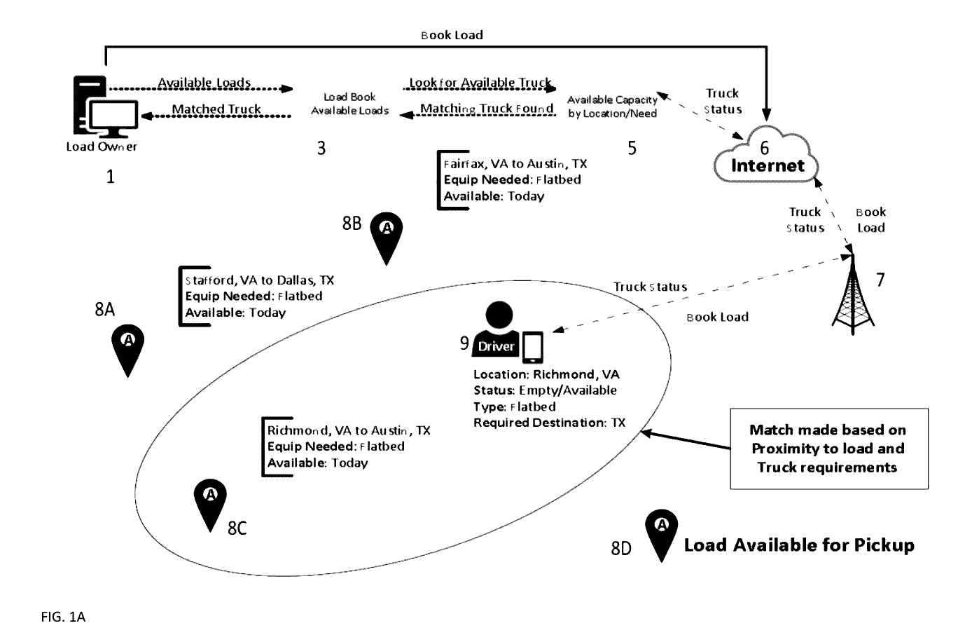

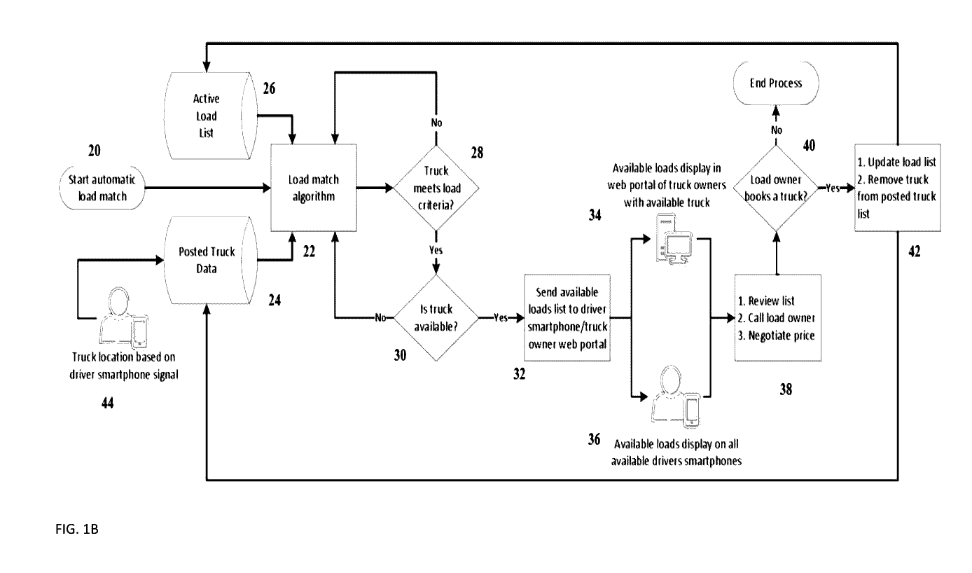

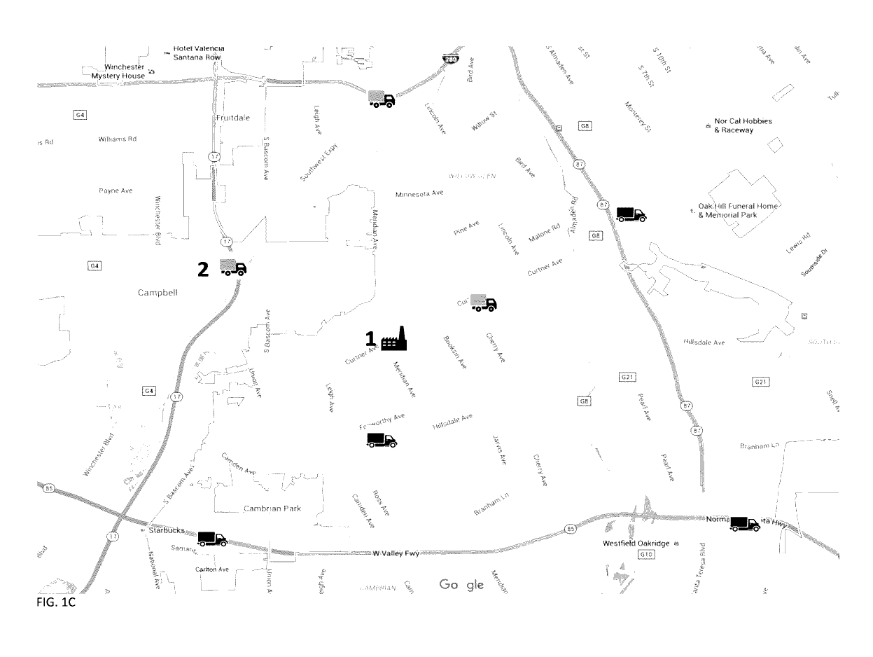

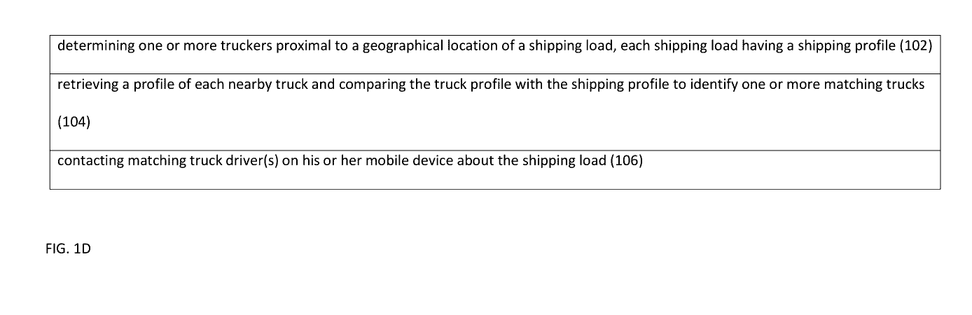

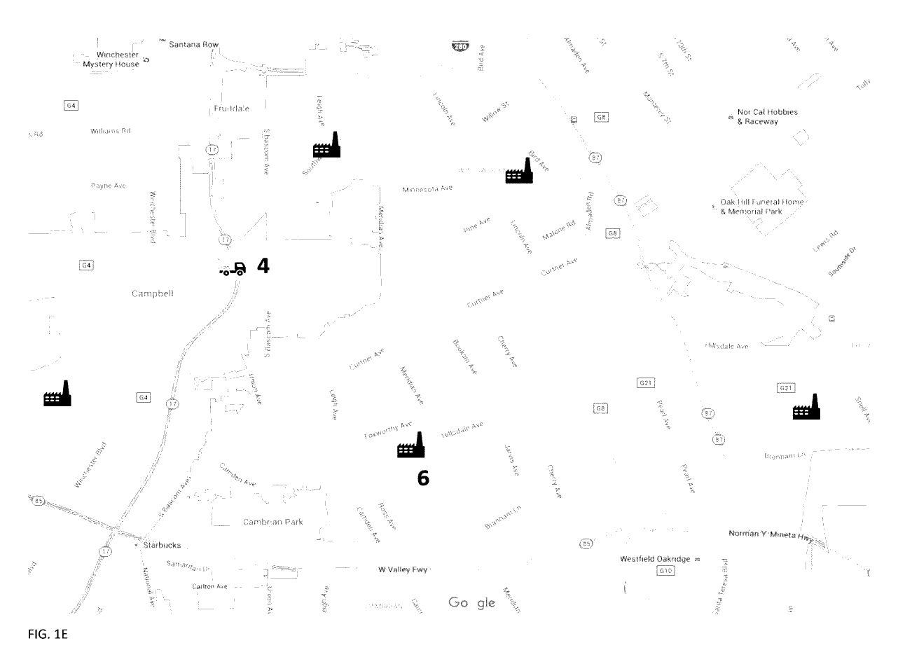

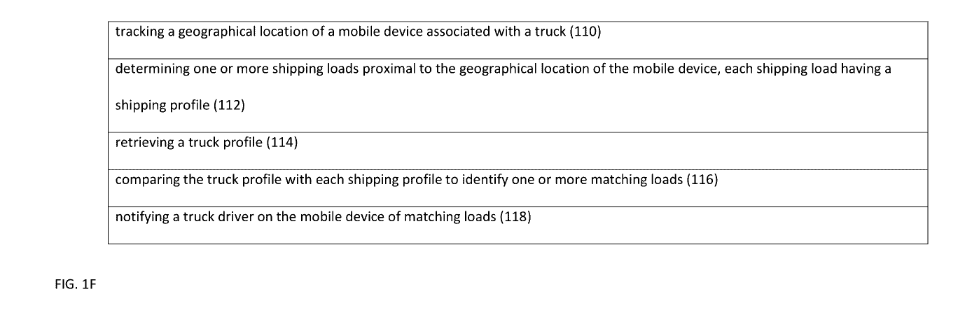

FIG. 1A shows an exemplary environment for matching truckers to loads. A load owner 1 (such as a manufacturer who needs to ship products) searches a load book database computer 3 for available load trucks. The database computer 3 searches a second database computer 5 for available capacity by location and/or need. The database computer 3 looks for available truck from database computer 5, and in response the computer 5 returns matching truck(s). The database computer 5 communicates truck status over the Internet 6 and such truck status and book load information can be wireless communicated using cellular towers 7, for example to a plurality of subscribers 8A-8D in various locations. In this example, the system matches driver 9 to load 8C based on proximity to load and truck requirements.

FIG. 1B shows an exemplary process for matching truckers to loads. From the start 20, the process runs a load matching engine 22 that receives posted truck data 24 and an active load list 26. The load match engine checks if the truck meets load criteria 28 and if not the next truck is tested for a matching load. If the load criteria is met, the process checks if the truck is available in 30 and if not the process loops back to 22 to process the next truck. If available, the process sends an available load list to the driver's smart phone and/or truck owner web portal in 32. The available loads are displayed in 34-36. The trucker then reviews the load and calls the load owner to negotiate price in 38. Next, if the load owner books the truck in 40, th load list is updated and truck is removed from the available list in 42 and the truck data is posted. Meanwhile, truck location is posted in the truck data 24 based on GPS and smart phone location transmissions in 44.

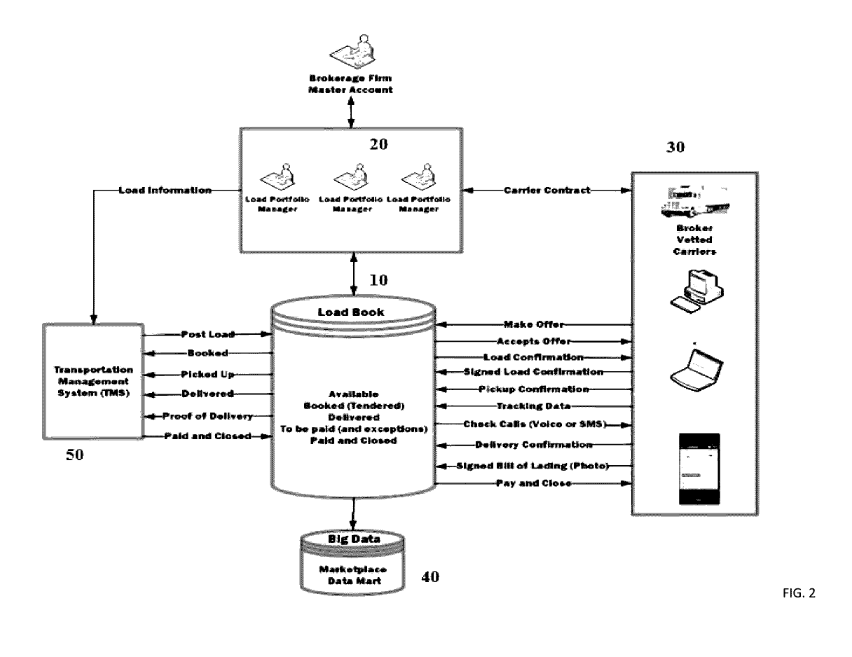

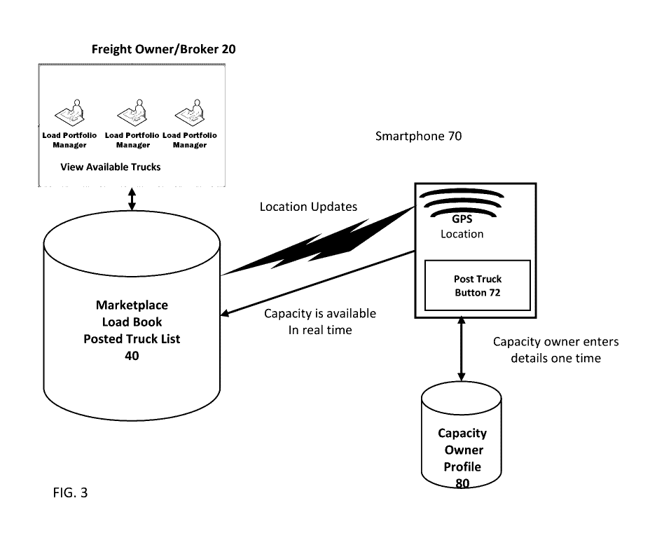

FIG. 1C shows an exemplary system to match shippers to truckers, while FIG. 1B shows an exemplary system to match a trucker with prospective customers. In FIG. 1A, a customer 1 (freight shipper or broker) views on a screen available trucks 2. Upon viewing the profile of each truck 2, the customer 1 can select one or more trucks for quotations and/or bidding. The customer would enter the load capacity desired, the type of load, the start and destination addresses, and desired delivery date. The information is then sent to the system of FIGS. 2 and 3 for communication with the truckers 2.

FIG. 1D shows an exemplary process to match shippers to truckers. The process includes determining one or more truckers proximal to a geographical location of a shipping load, each shipping load having a shipping profile (102). The process then rerieves a profile of each nearby truck and comparing the truck profile with the shipping profile to identify one or more matching trucks (104). The process then contacts matching truck driver(s) on his or her mobile device about the shipping load (106).

FIG. 1E shows a corresponding user interface for a trucker 4 looking for a customer. In FIG. 1B, a number of shipping prospects 6 are shown to the trucker 4. The trucker can retrieve each prospect's desired load capacity, type of load, the start and destination addresses, and desired delivery date and contact the prospect and/or provide a quote if there is a match.

FIG. 1F shows an exemplary process to match truckers to shippers. The process includes tracking a geographical location of a mobile device associated with a truck (110). The process determines one or more shipping loads proximal to the geographical location of the mobile device, each shipping load having a shipping profile (112). The process also includes retrieving a truck profile (114) and comparing the truck profile with each shipping profile to identify one or more matching loads (116). The process then messages a truck driver on the mobile device of matching loads (118). The process can include ratings by truckers and shippers of their respective performance. Posting capacity can be done without the time consuming search of truck boards. The information is centralized so that once done, the trucker availability, profile, and capacity information can be viewed by a variety of uses and available much sooner to the freight owner. Once the freight owner sees the available capacity, he/she could immediately engage the capacity owner and negotiate for his/her services. Thus, the capacity owner would not have to wait long for a booking and would be able to again be generating revenue from the engagement of the transportation asset. The system helps truckers find perfect client ahead of time. Truckers can build loyalty with large shipper or freight brokerage who pays well and who needs services regularly. The rating system allows truckers and shippers to operate on the basis of quality and service rather than being completely focused on getting the cheapest rate all the time.

FIG. 2 is a network diagram depicting an online shipping service transaction processing system for an automated transportation marketplace while FIG. 3 shows an exemplary system to capture truck profiles for the marketplace load book.

Turning now to FIG. 2, a load book 10 captures available loads for pick up, booked loads, delivered loads, deliveries waiting for payment, and paid/closed cases. The load book 10 is reviewed by a broker, which in turn can have sub-accounts each with a load portfolio manager, for example. The load book 10 also communicates with a plurality of carriers 30 through desktop computers, mobile computers, smart phones, among others. The carriers 30 can interact with the broker 20 to form contract directly, or can communicate through the load book 10 to offer and make/accept the offers. The carriers can also communicate load confirmation, pick up confirmation, provide tracking dta, check calls, provide delivery confirmation, signs bill of lading, and receive payments to close out a contract, among others. The load book 10 and the broker 20 can load data into a customer transportation management system (TMS) 50 to post loads, receive load booking, receive pick-up and delivery information, and pay/close a shipping case.

The load book 10 communicates with a market place data mart 40 which provides profiles of truckers, among others. The marketplace 40 of FIG. 1B receives location updates from each truck as the truck moves. Alternatively, the location can be communicated when a driver posts his/her location using a post truck button 72 on a smart phone 70 running an application thereon. The application also captures truck capacity and owner profiles, and such information is wirelessly uploaded to the marketplace 40. The profile information is typically entered once, and the capacity information can be entered once, and available capacity can be periodically updated depending on the utilization of the truck during a particular trip, for example. Using wireless communication protocols, location update and capacity information can be updated in real-time. In one embodiment, the trucker inputs the information on his/her capacity into a template supplied by the load board and may include type of equipment, amount of deadhead mileage the owner is willing to travel to position the capacity to the origin of the load, current location of the capacity and where the owner of the capacity would like for the capacity to end up.

The automated transportation system shown in FIGS. 1A and 1B can employ a client-server architecture, but it is not limited to such an architecture, and could equally well find application in a distributed, or peer-to-peer, architecture system. The various marketplace and payment applications also be implemented as standalone software programs, which do not necessarily have networking capabilities.

The web client can access various marketplace and payment applications via the web interface supported by the load book 10. Similarly, a programmatic client accesses the various services and functions provided by the marketplace and payment. The programmatic client may, for example, be a trucking application (e.g., the TruckerPath application developed by TruckerPath Inc., of San Jose, Calif.) to enable truckers to author and manage truck service listings on the marketplace 40 in an off-line manner, and to perform batch-mode communications between the programmatic client 30 and the network-based marketplace 40.

In one embodiment, the system of FIGS. 2-3 collects information in advance from the capacity owner, who would note the type of equipment, the desired amount of deadhead miles needed to reposition the equipment, the desired destination and the amount the capacity owner needed to be profitable when moving the freight. With this information already captured and stored in a carefully designed web based platform, the capacity owner's exact location is gleaned from his/her smartphone (or electronic handheld device) and then would be transmitted to the freight owner through the available cell network to the freight owners web portal with ‘one click’ of a digital button on the capacity owner's handheld device. Thus the capacity owner would post his/her available capacity to a transportation marketplace with a large number of freight owner members in a matter of milliseconds making the capacity available for use by a ready and willing freight owner population. In addition, should the capacity owner reposition his/her truck, the GPS would track the smartphone location and transmit it back to the transportation marketplace, keeping the freight owners up to date on the location of the empty capacity.

Truckers and customers/brokers who have entered into a transaction can rate each other at the end of the transaction. A Feedback score is then attached to each member profile. The Feedback score is one of the most important pieces of a Feedback Profile. The Feedback score is the number in parentheses next to a member's username, and is also located at the top of the Feedback Profile. Next to the Feedback score, the user or member may also see an icon such as a truck with colors. The number of positive, negative, and neutral Feedback ratings a member has received over time are part of the Feedback score. For each transaction, truckers and shippers/brokers can choose to rate each other by leaving Feedback. Shippers/Brokers can leave a positive, negative, or a neutral rating, plus a short comment. Truckers can leave a positive rating and a short comment.

The system of FIGS. 1A and 1B can support one or more features or functions on a website hosted by the third party. The third party website may, for example, provide one or more promotional, marketplace or payment functions that are supported by the relevant applications of the network-based marketplace 40.

The network-based marketplace 40 itself, or one or more parties that transact via the marketplace 40, may operate loyalty programs that are supported by one or more loyalty/promotions applications. For example, a shipper or broker may earn loyalty or promotions points for each transaction established and/or concluded with a particular trucker or carrier, and be offered a reward for which accumulated loyalty points can be redeemed.

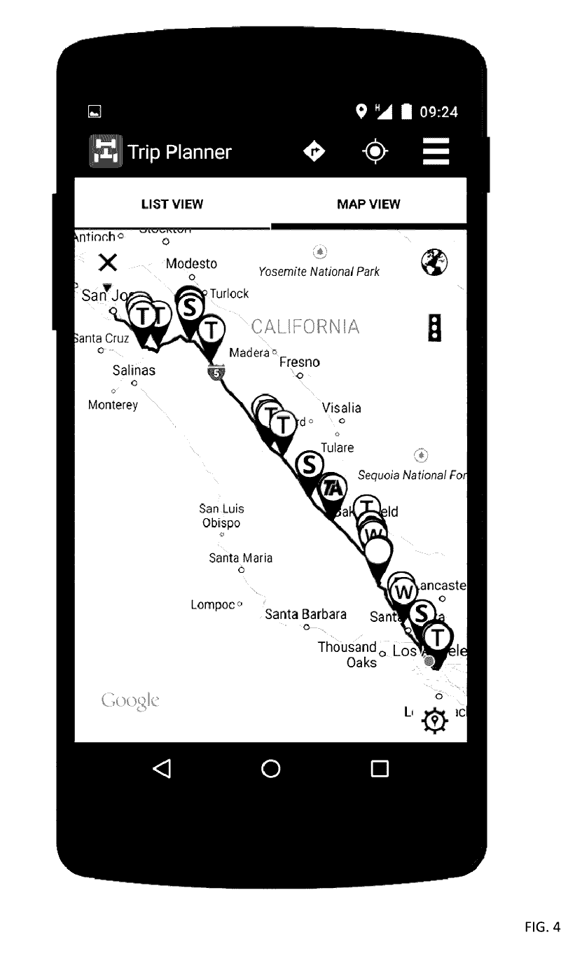

FIG. 4 shows an exemplary user interface of the Trucker Path app for trucker, which shows all major and independent truck stops, truck parking, rest areas, open/closed weigh stations, Walmart stores with truck parking, scales, truck washes, hotels and restaurants nearby. The information is constantly being verified and updated by other Trucker Path users and the team to ensure its accuracy.

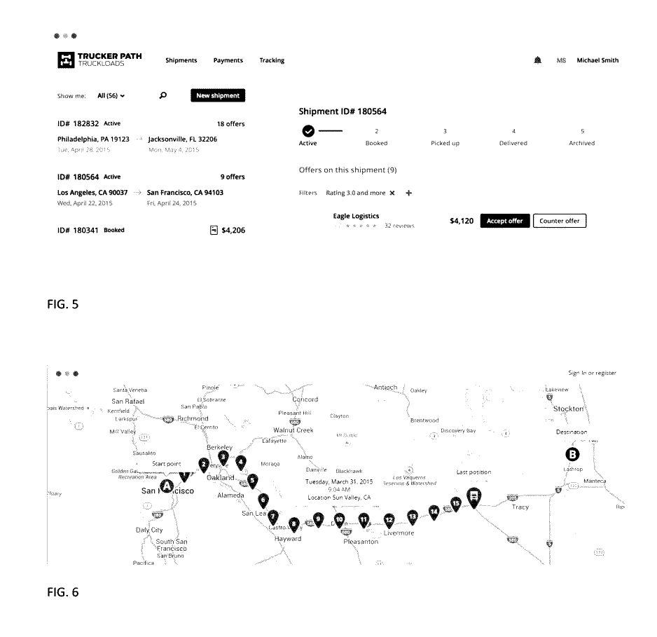

FIG. 5 shows an exemplary marketplace where shipper can request bids for shipping services. Upon mutual agreement as to price and delivery terms, the shipper and trucker enter into a binding a greement. As shown in FIG. 6, integrated in Trucker Path Truckloads—the tracking platform keeps shippers and brokers up to date on shipment location from pickup to delivery. The app helps carriers find nearby loads and connects them with top-rated brokers and shippers.

The TruckerPath Web site host may be configured to enable the user to view reputation information (e.g., feedback) with respect to another user. The user may request to view the reputation information associated with the opposite transacting party. Alternatively, the user may be presented with the relevant reputation information associated with the opposite transacting party responsive to the user's request to enter into a transaction with another user. The overall view may be provided to the user according to the requesting user's preferences stored in “User Preferences”. A view of associated reputation information is then retrieved from the feedback score table stored in “Feedback Score” and the feedback left score table stored in “Feedback Left Score”. If the user desires details, then the details may be presented (e.g., in paginated format) utilizing “Feedback Detail History Overall” and “Feedback Detail History”. The user may be enabled selectively to access reputation information according to criteria such as promptness of payment information, quality of performance information, timeliness of performance information, or promptness of response information as well as according to other criteria. Other criteria may be, but not limited to, shipping, packaging, item accurately described, promptness of leaving feedback, was the item returned by the shipper, was there a non-payment, when was the item received, etc.

Although the components of the system are described as individual exemplary modules, the functionality of one or more exemplary modules may be combined in an alternative embodiment of the present invention. For example, the system 180 may be configured such that the functions performed by the feedback quality score generator 196 and the feedback score adjusting module 194 are performed by a single module.

The above system is run by a computer within which a set of instructions (e.g., software) may be executed for causing client computers and server computers mentioned above to perform the methods of the present invention. In alternative embodiments, hard-wired circuitry may be used in place of or in combination with software instructions to implement the invention. Thus, embodiments of the invention are not limited to any specific combination of hardware circuitry and software.

Thus, method and apparatus for providing and displaying enhanced feedback in an online transaction processing environment has been described. Although the present invention has been described with reference to specific exemplary embodiments, it will be evident that various modifications and changes may be made to these embodiments without departing from the broader scope and spirit of the invention. Accordingly, the specification and drawings are to be regarded in an illustrative rather than a restrictive sense.

What is claimed is:

1. A computer-implemented method to match a truck to a company with a load to ship, comprising:
tracking a geographical location of a mobile device associated with a truck;
determining one or more shipping loads proximal to the geographical location of the mobile device, each shipping load having a shipping profile;
retrieving a truck profile;
comparing the truck profile with each shipping profile to identify one or more matching loads; and
notifying a truck driver on the mobile device of matching loads.

2. The method of claim 1, comprising sending a notification to the device of a nearby position of the load, the nearby position of the load related to one or more categories of interest, the notification sent in response to proximity of the geographical location of the device relative to the position of the load.

3. The method of claim 2, further comprising specifying the category of interest manually or learning the category of interest automatically.

4. The method of claim 1, further comprising applying geo-fencing to trigger proximity of the truck driver device to the position of the load.

5. The method of claim 1, further comprising automatically discovering new loads or points of interest in proximity to the truck driver device based on a detected change in the geographical location of the truck driver device.

6. The method of claim 1, further comprising creating and updating a repository that includes a category of interest in association with the truck driver device, geolocation information for movable loads, temporary loads, and new loads.

7. The method of claim 1, further comprising creating and presenting a list of points of interest on the truck driver device as the notification to the truck driver and for truck driver interaction.

8. The method of claim 1, comprising collecting feedback on delivery performance.

9. The method of claim 8, comprising requesting generic rating information related to a load delivery.

10. The method of claim 8, comprising requesting specific rating information related the plurality of performance categories.

11. A computer-implemented method to match a shipper with a load to ship with one or more truckers, comprising:
determining one or more truckers proximal to a geographical location of a shipping load, each shipping load having a shipping profile;
retrieving a profile of each nearby truck and comparing the truck profile with the shipping profile to identify one or more matching trucks; and
contacting matching truck driver(s) on his or her mobile device about the shipping load.

12. The method of claim 11, comprising communicating with a broker affiliated with the shipper.

13. The method of claim 11, comprising providing a load book database to store available loads for pick up, booked loads, delivered loads, deliveries waiting for payment, and paid/closed cases. T

14. The method of claim 13, wherein the load book is reviewed by a broker or one or more load portfolio managers.

15. The method of claim 13, wherein the trucker communicates load confirmation, pick up confirmation, tracking data, check calls, delivery confirmation, bill of lading, and payments to the load book.

16. The method of claim 11, comprising communicating with a customer transportation management system (TMS) to post loads, receive load booking, receive pick-up and delivery information, and pay a shipping case.

17. The method of claim 11, comprising providing a market place data mart with profiles of truckers.

18. The method of claim 17, comprising receiving location updates from each truck as the truck moves or upon actuating button on an application.
